(19) United States
(12) Patent Application Publication
(10) Pub. No.: US 2001/0040955 A1
(43) Pub. Date: Nov. 15, 2001

(54) Directory services for electronic voice and data transmission

(75) Inventors: Bernie B. Zolner, Edmonton (CA); Robert J. Gylytiuk, Edmonton (CA); Gary C. Gylytiuk, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Robert J. Gylytiuk

(21) Appl. No.: 09/730,709

(22) Filed: Dec. 5, 2000

(30) Foreign Application Priority Data
May 9, 2000 (CA) 2,308,010

(51) Int. Cl. H04M 3/42

(52) U.S. Cl. 379/218.01; 379/201.01

(57) ABSTRACT

A directory service for electronic voice and data transmission includes a database in which at least one of old telephone numbers, E-Mail addresses and domain names that are no longer in service are stored, along with corresponding new telephone numbers, E-Mail addresses and domain names. An interface is provided which enables a member of the public to enter an old telephone number, an old E-Mail address or an old domain name and be given in response a corresponding new telephone number, new E-Mail address or new domain name.

### FIELD OF THE INVENTION

The present invention relates to a directory service for electronic voice and data transmission and, in particular, directory services relating to changes in cellular telephone numbers and changes in E-Mail addresses or domain names on the world wide web.

### BACKGROUND OF THE INVENTION

Telephone companies provide services to facilitate a transition to a new telephone number. The person or business with a changed telephone number can request that, for a short time duration, all callers to the old telephone number receive a recorded message advising as to the new telephone number. After the time duration of the recorded message expires, the public can still determine the new telephone number through an alphabetical directory service.

There are many electronic voice and data transmission mediums for which there are no directory services available. For example, there are no directories on the world wide web to facilitate a change in E-Mail address or domain name.

In the highly competitive cellular telephone and electronic pager markets, there are no directories available to facilitate a change in telephone number. One of the reasons the companies involved in these markets do not offer a directory service, is that they do not wish to facilitate a move to one of their competitors.

Even in the more traditional telephone markets, there are short comings in the directory services provided. For example, the existing directory services are not available where a person or business moves to a geographical area having a different area code.

In the area of cellular telephones, a solution has been proposed which would eliminate the need for directory services by making phone numbers “portable”. With this solution a telephone number would belong to the customer. The customer would take the telephone number with him or her when changing telephone companies. This solution has been opposed by the telephone companies involved as being unworkable with existing infrastructure.

### SUMMARY OF THE INVENTION

What is required is a more all encompassing directory service that can be used for electronic voice and data transmission.

According to the present invention there is provided a directory service for electronic voice and data transmission which includes a database in which at least one of old telephone numbers, E-Mail addresses and domain names that are no longer in service are stored, along with corresponding new telephone numbers, E-Mail addresses and domain names. An interface is provided which enables a member of the public to enter one of an old telephone number, an old E-Mail address and an old domain name and be given in response a corresponding new telephone number, new E-Mail address or new domain name.

With the directory service, as described above, persons experience a change in their telephone number, E-Mail address or domain name can post a public notice of the change. Members of the public unable to reach a person or business due to a change, are able to enter the old telephone number, E-Mail address or domain name; and receive the new one in response.

There are different forms that the interface may take. It is envisaged that two forms of interface will be most commonly used a telephone interface and an interface through the world wide web, as will be hereinafter further described.

One of the advantages of this directory service is that it requires a minimum of information in order to function. The only essential information to the functioning of the database is the old telephone number, E-Mail address or domain name and the corresponding new telephone number, E-Mail address or domain name. This simplicity enables data input to be made into the database by individual customers who are experiencing a change in one of their telephone number, E-Mail address and domain name.

Whenever data input is made by individual customers, there are security problems to be addressed. In addition, in order to run the directory service as a business some means must be made of obtaining payment. Even more beneficial results may, therefore, be obtained when payment is made for the directory services by issuing to individual customers prepaid debit cards having associated personal identification numbers. With this approach the customers prepay for the service. Individual customers have control over data entry only for one old and corresponding new entry pairing. Security is maintained to that pairing through the personal identification number.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a block diagram of a directory service for electronic voice and data transmission configured in accordance with the teachings of the present invention.

FIG. 2 is a flow diagram representing operation of the interface to the directory service of FIG. 1.

### DETAILED DESCRIPTION OF THE PREFERRED EMBODIMENT

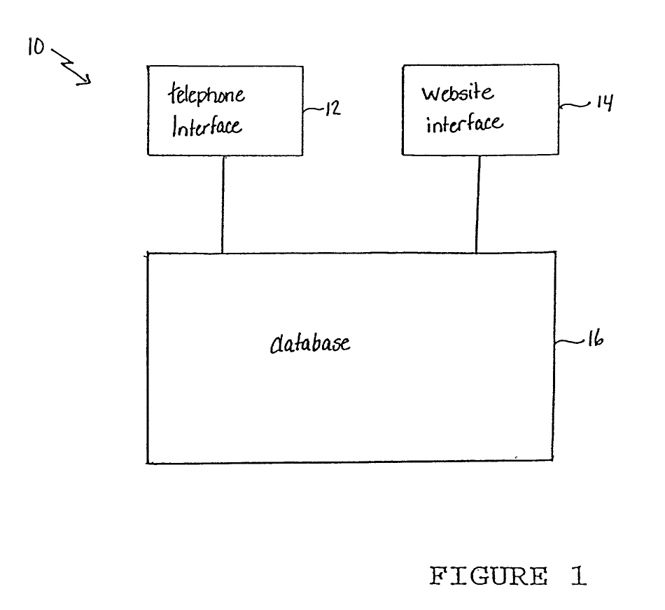

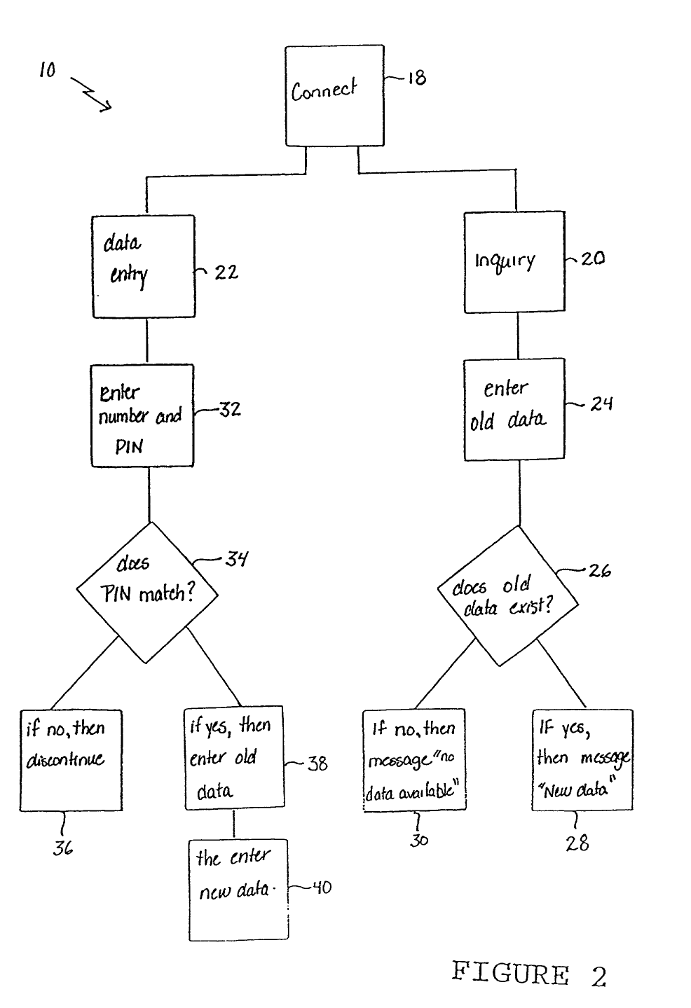

The preferred embodiment, a directory service for electronic voice and data transmission generally identified by reference numeral 10, will now be described with reference to FIGS. 1 and 2.

### Structure and Relationship of Parts

Referring to FIG. 1, directory service 10 includes a database 16 in old telephone numbers, E-Mail addresses and domain names that are no longer in service are stored, along with corresponding new telephone numbers, E-Mail addresses and domain names. Directory service 10 provides two alternative interfaces, a telephone interface 12 and a website interface 14 on the world wide web. The operation of these interfaces will hereinafter be further described. Telephone interface 12 enables a member of the public to enter an old telephone number through a key pad of a telephone and be given an auditory response of a corresponding new telephone number. Website interface 14 has more flexibility regarding entry of alpha-numeric characters enabling a member of the public to enter through a computer keyboard one of an old telephone number, an old E-Mail address or an old domain name and be given a graphically displayed response of a corresponding new telephone number, new E-Mail address or new domain name.

Data input into database 16 is made by individual customers who are experiencing a change in their telephone number, E-Mail address or domain name. Payment can be made for directory services 10 in various ways, for example, by issuing to individual customers prepaid debit cards. Where system access is provided by assigning to the prepaid debit cards given to individual customers associated personal identification numbers. Each of the personal identification numbers provides access to a single pair of an old telephone number and a corresponding new telephone number, an old E-Mail address and a corresponding new E-Mail address, or an old domain name and a corresponding new domain name.

### Operation

Referring to FIG. 2, a user may choose to connect 18 to directory service 10 using telephone interface 12 or web site interface 14. When the user connects 18 to directory service 10 using telephone interface 12, an automated voice message will prompt the user with the option of making an inquiry 20 for a new phone number by entering the old phone number, or with the option of entering data 22 regarding a change in phone numbers.

If the user is a member of the general public seeking to obtain the new phone number of another person whose number is no longer in service, they will choose the option of making an inquiry 20 by entering the ten digits of the old phone number of the person they are seeking 24. Directory service 10 will then query 26 database 16 for the old phone number and determine if there is a corresponding new phone number associated with the old phone number. If a corresponding new phone number is found to be associated with the old phone number, then the user will hear an auditory response informing the user of the new phone number 28. If no new phone number is associated with the old phone number, the user will hear an auditory response informing them that no new forwarding phone number is listed for the old phone number 30.

If the user who connects 18 to directory service 10 through phone interface 12 is an individual customer who is experiencing a change in their phone number and wishes to have a new forwarding number associated with their old phone number, the user will respond to the auditory response prompt by pressing the “#” key on the telephone key pad 22. An auditory prompt will then ask the user to input the number located on the prepaid debit card and the associated personal identification number 32. Directory services 10 will query if the personal identification number is valid for that prepaid debit card 34. If the personal identification number is not valid, the user will hear an auditory response informing the user that the personal identification number is not valid and telephone interface 12 will discontinue 36. If the personal identification number is validly associated with the prepaid debit card number, the user will hear an auditory prompt asking them to enter the ten digits of their old phone number that is no longer in service 38. Once the old phone number has been properly entered, an auditory prompt will ask the user to enter the new phone number to which the user wishes to have their phone calls directed to 40.

Referring to FIG. 1, once the new phone number has been properly entered into database 16, the new phone number will then be made available to anyone from the general public who makes an inquiry regarding the old number through either telephone interface 12 or web site interface 14.

Referring to FIG. 2, if a user chooses to connect 18 to directory service 10 using website interface 14 the interaction with the user is substantially the same as with the telephone interface 12 described above. Web site interface 14 has a greater capability to handle alpha-numeric characters and can, therefore also handle changes in E-Mail addresses or domain names. When the user connects 18 to directory service 10 using website interface 14, a screen display message will prompt the user with the option of making an inquiry 20 for one of a new phone number, E-mail, and domain name by entering the old phone number, E-mail, and domain name, or with the option of entering data 22 regarding a change in phone number, E-mail, or domain name.

If the user is a member of the general public seeking to obtain the new phone number, E-mail, or domain name of another person whose phone number, E-mail, or domain name is no longer in service, they will choose the option of making an inquiry 20 by entering the old phone number, E-mail, or domain name of the person they are seeking 24. Directory service 10 will then query 26 database 16 for the old phone number, E-mail, or domain name and determine if there is a corresponding new phone number, E-mail, or domain name. If a corresponding new phone number, E-mail, or domain name is found to be associated with the old phone number, E-mail, or domain name, then the user will see a screen displayed message informing the user of the new phone number, E-mail, or domain name 28. If no new phone number, E-mail, or domain name is found to be associated with the old phone number, E-mail, or domain name, the user will view a screen displayed message informing them that no new forwarding phone number, E-mail, or domain name is listed for the old phone number, E-mail, or domain name 30.

If the user who connects 18 to directory service 10 through website interface 14 is an individual customer who is experiencing a change in one of their phone number, E-mail, or domain name and wishes to have a new forwarding phone number, E-mail, or domain name associated with their old phone number, E-mail, or domain name, the user will input the number located on the prepaid debit card and the associated personal identification number 32. Directory services 10 will query if the personal identification number is valid for the prepaid debit card 34. If the personal identification number is not valid, the user will view a screen displayed message informing the user that the personal identification number is not valid and website interface 14 will discontinue 36. If the personal identification number is validly associated with the prepaid debit card number, the user will view a screen displayed prompt asking them to enter their old phone number, E-mail, or domain name that is no longer in service 38. Once the old phone number, E-mail, or domain name has been properly entered, a screen displayed message will ask the user to enter the new phone number, E-mail, or domain name to which the user wishes to have their phone calls, E-mails, or domain name queries directed to 40.

Referring to FIG. 1, once the new phone number, E-mail, or domain name has been registered in database 16, the new phone number, E-mail and domain name will then be made available to any individual from the general public who makes an inquiry 20 through either telephone interface 12 or website interface 14.

In the claims to this patent the term “alpha-numeric alpha-numeric communications media identifiers” has been used. This term is intended to encompass telephone numbers, fax phone numbers, domain names, internet protocol addresses, cellular telephone numbers, and any other identifiers which may come to be used with the apparent convergence of the various types of communications media such as telephone, television and the world wide web.

A person adopting this information may chose to provide additional information in addition to the old alpha-numeric communications media identifier and the new alpha-numeric communications media identifier. However, one of the advantages of the directory services described above, is that the only information necessary is the old identifier and the new identifier. This is provides a tremendous advantage in the area of protection of privacy, in combination with the fact that without the old identifier you cannot obtain the new identifier.

At the present time payment cards appear to be the most viable payment option. It will be appreciated, however, that a card need not be used. A PIN number may be given in exchange for payment. The mode of payment may and undoubtedly will change as commerce on the world wide web become further developed.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A directory service for electronic voice and data transmission, comprising:
a database in which old alpha-numeric communications media identifiers that are no longer in service are stored, along with corresponding new alpha-numeric communications media identifiers; and
an interface which enables a member of the public to enter one of the old alpha-numeric communications media identifiers and be given in response a corresponding one of the new alpha-numeric communications media identifiers.

2. The directory services as defined in claim 1, the alpha-numeric communications media identifiers being at least one of old telephone numbers, E-Mail addresses and domain names.

3. The directory service as defined in claim 1, wherein the interface is a web page on the world wide web.

4. The directory service as defined in claim 1, wherein the interface is a telephone.

5. The directory service as defined in claim 1, wherein data input into the database is made by individual customers who are experiencing a change in their alpha-numeric communications media identifiers.

6. The directory service as defined in claim 4, wherein payment is made for the directory services by issuing to individual customers prepaid debit cards.

7. The directory service as defined in claim 4, wherein system access is provided by assigning to individual customers associated personal identification numbers.

8. The directory service as defined in claim 4, wherein each of the personal identification numbers provides access to a single pair of one the old alpha-numeric communications media identifiers and one of the corresponding new alpha-numeric communications media identifiers.

9. A directory service for electronic voice and data transmission, comprising:
a database in which old telephone numbers, E-Mail addresses and domain names that are no longer in service are stored, along with corresponding new telephone numbers, E-Mail addresses and domain names, data input into the database being made by individual customers who are experiencing a change in one of their telephone number, E-Mail address and domain name; and
an interface through a web page on the world wide web which enables a member of the public to enter one of an old telephone number, an old E-Mail address and an old domain name and be given in response one of a corresponding new telephone number, new E-Mail address and new domain name.

10. A directory service for electronic voice and data transmission, comprising:
a database in which old telephone numbers that are no longer in service are stored, along with corresponding new telephone numbers, input into the database being made by individual customers who are experiencing a change in their telephone number; and
an interface by telephone with data entry through a telephone keypad which enables a member of the public to enter an old telephone number and be given an auditory response as to a corresponding new telephone number.
